(19) United States
(12) Patent Application Publication
(10) Pub. No.: US 2022/0149383 A1
(43) Pub. Date: May 12, 2022

(54) CURRENT COLLECTOR FOR SECONDARY BATTERY

(71) Applicant: KOREA JCC CO., LTD., Cheongwon-gun (KR)

(72) Inventors: Dal Woo SHIN, Cheongju-si (KR); Jin Sik SHIN, Cheongju-si (KR); Mi Hyun OH, Cheongju-si (KR); Sung Han KIM, Cheongju-si (KR); Ji Yoon PARK, Cheongju-si (KR)

(21) Appl. No.: 17/112,167

(22) Filed: Dec. 4, 2020

(30) Foreign Application Priority Data
Nov. 12, 2020 (KR) 10-2020-0151050

(51) Int. Cl. H01M 4/66; H01M 4/80

(52) U.S. Cl. CPC H01M 4/667; H01M 4/80; H01M 2004/021; H01M 4/664; H01M 4/668; H01M 4/661

(57) ABSTRACT

Provided is a current collector 30, including a metal foil 5 having a plurality of first through holes 5a, a metal oxide film 15 formed on a top or bottom surface of the metal foil 5, and a conductive layer 25 formed on a top or bottom surface of the metal oxide film 15. The plurality of first through holes 5a is filled with a conductive connection member 10 to form the metal foil 5. The metal oxide film 15 is formed to have second through holes 15a at locations corresponding to the plurality of first through holes 5a, respectively, on the top or bottom surface of the metal foil 5. The conductive layer 25 is formed to have a third through hole 25a at a location corresponding to each of the second through holes 15a on a top or bottom surface of the metal oxide film 15.

This invention was made with government support as follows: Government Department: Ministry of Trade, Industry and Energy; Research Management Specialized Agency: Korea Evaluation Institute of Industrial Technology; Research Project: Material Component Technology Development Project (Demand Natural System Technology Development Project); Research Task: Super-Power (RC time ≤0.41 s) Supercapacitor Development for Energy Recovery; Managing department; SAMWHA ELECTRIC CO., LTD; and Research Period: Apr. 1, 2017 to Dec 31, 2020.

### BACKGROUND OF THE INVENTION

### 1. Technical Field

The present disclosure relates to a current collector for a secondary battery and, more particularly, to a current collector for a secondary battery, which can improve durability by removing a natural oxide film of a metal foil and forming a separate metal oxide film and can prevent the degradation of an equivalent series resistance characteristic between electrode material layers by forming a conductive layer on a surface of the metal oxide film.

### 2. Description of the Related Art

Conventionally, an electrochemical device represented as a lithium-ion battery is used for small-sized uses, such as a mobile phone and a notebook computer, and for large-sized uses, such as a vehicle, in that the electrochemical device has high energy density and output density. Accordingly, the electrochemical device requirements improvements for low resistance, a high capacity, a high-withstanding voltage, mechanical characteristics, and cycle lifespan. In order to reduce the internal resistance of the electrochemical device, a current collector technology for a secondary battery in which an adhesive composition is applied between an electrode active material layer and a current collector is disclosed in Japanese Patent No. 4909443 (Patent Document 1).

The current collector for a secondary battery disclosed in Japanese Patent No. 4909443 includes an aluminum foil, and a coating formed on the aluminum foil, having a thickness 0.1 μm or more to 10 μm or less, and including one or more kinds of carbon particles, selected from a group consisting of acetylene black, Ketjen black, an evaporation method carbon fiber, and graphite, and polysaccharide polymers cross-linked by a cross-linking agent.

There is a concern that as in Japanese Patent No. 4909443, coating irregularity may occur in a conventional current collector for a secondary battery because a lot of gel is included in an adhesive composition when an adhesive composition is coated on the current collector in order to form a conductive additive layer. Accordingly, there is a disadvantage in that the cycle characteristic (e.g., lifespan) of the secondary battery is deteriorated because adhesiveness between the conductive additive layer and the current collector is reduced.

### PRIOR ART DOCUMENT

### Patent Document

(Patent Document 1) : Japanese Patent No. 4909443

### SUMMARY OF THE INVENTION

The present disclosure has been made keeping in mind the above problems occurring in the prior art, and the present disclosure provides a current collector for a secondary battery, which can improve durability by removing a natural oxide film of a metal foil and forming a separate metal oxide film and can prevent the degradation of an equivalent series resistance characteristic between electrode material layers by forming a conductive layer on a surface of the metal oxide film.

The present disclosure provides a current collector for a secondary battery, which can improve an adhesive force when an electrode material is coated by forming a plurality of through holes and forming a conductive connection member within the hole.

In an aspect, a current collector 30 includes a metal foil 5 having a plurality of first through holes 5a, a metal oxide film 15 formed on a top or bottom surface of the metal foil 5, and a conductive layer 25 formed on a top or bottom surface of the metal oxide film 15. The plurality of first through holes 5a is filled with a conductive connection member 10 to form the metal foil 5. The metal oxide film 15 is formed to have second through holes 15a at locations corresponding to the plurality of first through holes 5a, respectively, on the top or bottom surface of the metal foil 5. The conductive layer 25 is formed to have a third through hole 25a at a location corresponding to each of the second through holes 15a on a top or bottom surface of the metal oxide film 15.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a cross-sectional view illustrating an embodiment of a current collector for a secondary battery according to an embodiment of the present disclosure.

FIG. 2 is a cross-sectional view illustrating the state in which a plurality of holes has been formed in a metal foil illustrated in FIG. 1.

FIG. 3 is a cross-sectional view illustrating the state in which a metal connection member has been formed in each of the plurality of holes illustrated in FIG. 2.

FIG. 4 is a cross-sectional view illustrating the state in which a metal oxide film has been formed in the metal foil illustrated in FIG. 3.

FIG. 5 is a cross-sectional view illustrating the state in which an electrode material layer has been formed in the current collector illustrated in FIG. 1.

FIG. 6 is a cross-sectional view illustrating a current collector for a secondary battery according to another embodiment of the present disclosure.

### DESCRIPTION OF REFERENCE NUMERALS

5: metal foil 10: conductive connection member
15: metal oxide film 25: conductive layer
30: current collector

### DETAILED DESCRIPTION

Hereinafter, embodiments of the present disclosure are described in detail with reference to the accompanying drawings.

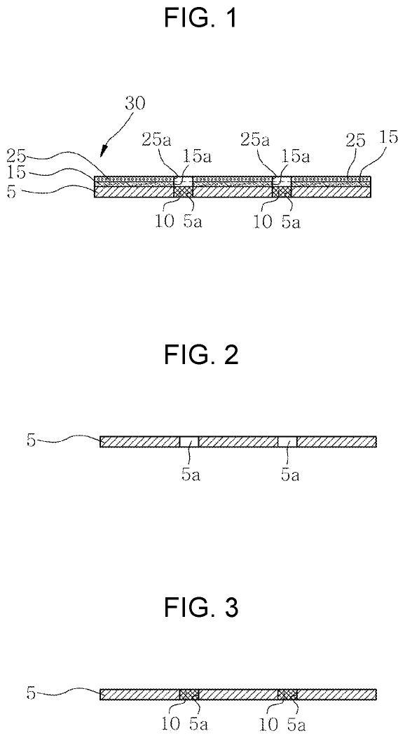

As illustrated in FIGS. 1 to 4, a current collector 30 for a secondary battery according to an embodiment of the present disclosure is configured to include a metal foil 5, a conductive connection member 10, a metal oxide film 15, and a conductive layer 25. That is, the current collector 30 for a secondary battery according to an embodiment of the present disclosure includes the metal foil 5 having a plurality of first through holes 5a, the metal oxide film 15 formed on a top or bottom surface of the metal foil 5, and the conductive layer 25 formed on a top or bottom surface of the metal oxide film 15.

The metal foil 5 is formed by filling the plurality of first through holes 5a with the conductive connection member 10. The metal oxide film 15 is formed to have a second through hole 15a at a location, corresponding to each of the plurality of first through holes 5a, on the top or bottom surface of the metal foil 5. The conductive layer 25 is formed to have a third through hole 25a at a location, corresponding to the second through holes 15a, on the top or bottom surface of the metal oxide film 15.

One of aluminum, copper, and nickel is used as a material for each of the metal foil 5 and the conductive layer 25.

Each of the plurality of first through holes 5a has a diameter of 10 to 100 μm. An interval between the first through holes 5a is 50 to 500 μm.

The conductive connection member 10 is filled into each of the plurality of first through holes 5a using a conductive adhesive material so that the conductive connection member is formed to have a height identical with the depth of each of the plurality of first through holes 5a. Silver (Ag) epoxy is used as the conductive adhesive material.

The second through hole 15a formed in the metal oxide film 15 and the third through hole 25a formed in the conductive layer 25 are formed at a location corresponding to the first through hole 5a, and thus communicate with the first through hole 5a. When an electrode material layer 26 is formed on the conductive layer 25, the second through hole 15a and the third through hole 25a are filled with the electrode material layer 26, so that the electrode material layer 26 is connected to a conductive connection member 10 formed in the first through hole 5a.

A method of fabricating the current collector 30 for a secondary battery according to an embodiment of the present disclosure is schematically described as follows.

The metal foil 5 has a thickness of 1 to 5 μm, and one of aluminum, copper, and nickel is used as a material for the metal foil 5. As illustrated in FIG. 2, the plurality of first through holes 5a into which the conductive connection member 10 is filled is formed in the metal foil 5. Each of the plurality of first through holes 5a has a diameter of 10 to 100 μm. An interval between the holes 5a is 10 to 500 μm. In this case, the interval may be narrower compared to a case where a photo etching process is applied. When a puncturing method using a laser apparatus (not illustrated) is applied, the interval may be wider compared to a case where a photolithography process is applied. Accordingly, productivity in a task for fabricating the plurality of first through holes 5a can be improved.

As illustrated in FIG. 3, the conductive connection member 10 is formed to have a height identical with the depth of each of the plurality of first through holes 5a. The plurality of first through holes 5a is filled with the conductive adhesive material. Silver (Ag) epoxy is used as the conductive adhesive material. That is, the conductive connection member 10 is formed to have a thickness identical with the depth of the hole 5a using silver (Ag) epoxy, that is, a conductive adhesive material. As illustrated in FIG. 5, when formed, the electrode material layer 26 is connected and attached to a top or bottom surface of the conductive connection member 10.

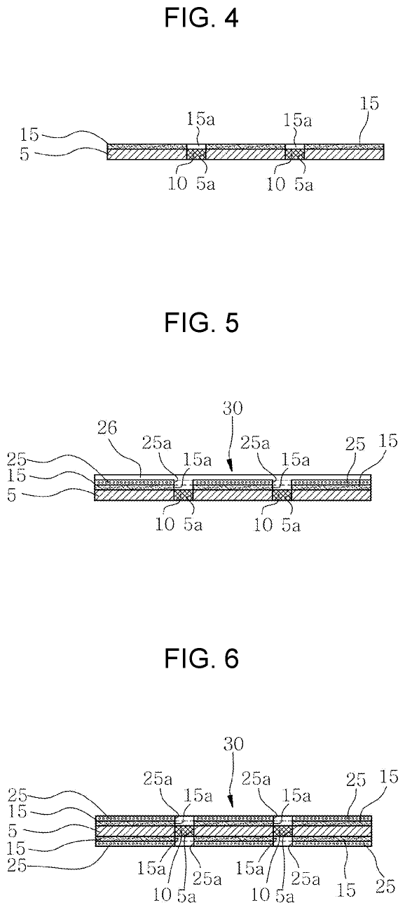

As illustrated in FIG. 4, the metal oxide film 15 is formed to have the second through hole 15a at a location, corresponding to each of the plurality of first through holes 5a, on the top or bottom surface of the metal foil 5. If a material for the metal foil 5 is aluminum, the metal oxide film 15 is formed by sputtering alumina (Al₂O₃). The metal oxide film 15 may be formed using a metal oxidization method or a chemical vapor deposition method in addition to sputtering. The metal oxide film 15 is formed to have the second through hole 15a at a location corresponding to each of the plurality of first through holes 5a. That is, the plurality of second through holes 15a is formed in the metal oxide film 15. Each of the plurality of second through holes 15a is formed at a location corresponding to the first through hole 5a, and communicates with the first through hole 5a. More specifically, the plurality of second through holes 15a is prepared in the metal oxide film 15. Each of the plurality of second through holes 15a has the same diameter as the first through hole 5a. An interval between the second through holes 15a is the same as an interval between the first through holes 5a.

The plurality of second through holes 15a is formed by first coating a photoresist pattern (not illustrated) on the top or bottom surface of the metal foil 5, forming the metal oxide film 15, and then removing the photoresist pattern after the metal oxide film 15 is formed. In this case, the photoresist pattern is formed at a location where the second through holes 15a will be formed and removed after the metal oxide film 15 is formed. Accordingly, the second through holes 15a are formed by the removal of the photoresist pattern. That is, the photoresist pattern is formed on the top or bottom of the conductive connection member 10 in a cylindrical pattern. Since the second through hole 15a communicates with the first through hole 5a, the top or bottom of the conductive connection member 10 formed in the first through hole 5a is exposed to the outside through the second through hole 15a.

As illustrated in FIGS. 1 and 5, the conductive layer 25 is formed to have the third through holes 25a at locations corresponding to the second through holes 15a, respectively, on the top or bottom surface of the metal oxide film 15. One of aluminum, copper, and nickel is used as a material for the conductive layer 25. The conductive layer 25 is formed using a deposition, sputtering, plating, printing or chemical vapor deposition method. The third through hole 25a is formed at location corresponding to the second through hole 15a in the conductive layer 25. That is, the plurality of third through holes 25a is formed in the conductive layer 25. Each of the plurality of third through holes 25a is formed at a location corresponding to the second through hole 15a, and is formed to communicate with the second through hole 15a. More specifically, the plurality of third through holes 25a is prepared in the conductive layer 25. Each of the plurality of third through holes 25a has the same diameter as the first through hole 5a, and an interval between the third through holes 25a is the same as an interval between the first through holes 5a.

In a method of fabricating the plurality of third through holes 25a, after a photoresist pattern (not illustrated) is coated on the top or bottom surface of the metal oxide film 15, the conductive layer 25 is formed, and the third through holes 25a are formed by removing the photoresist pattern after the conductive layer 25 is formed. That is, the plurality of third through holes 25a is formed using the same process as that of the method of fabricating the second through holes 15a. Since the third through hole 25a communicates with the second through hole 15a, the top or bottom of the conductive connection member 10 is exposed to the outside through the third through hole 25a.

The second through hole 15a formed in the metal oxide film 15 and the third through hole 25a formed in the conductive layer 25 are formed at a location corresponding to the first through hole 5a, and communicate with the first through hole 5a. When the electrode material layer 26 is formed on the conductive layer 25, the first through hole 5a, the second through hole 15a, and the third through hole 25a are filled with the electrode material layer 26, so that the electrode material layer 26 is connected to the conductive connection member 10 formed in the first through hole 5a.

For example, when the electrode material layer 26 is formed on the top or bottom of the conductive layer 25, the second through hole 15a and the third through hole 25a are filled with the electrode material layer 26. After the second through hole 15a and the third through hole 25a are filled with the electrode material layer 26, the electrode material layer 26 is connected to the top or bottom of the conductive connection member 10. As described above, when the electrode material layer 26 is connected to the top or bottom of the conductive connection member 10, the electrode material layer 26 is firmly connected and supported by the top or bottom surface of the conductive layer 25. In this case, one of carbon, lithium cobalt oxide (LCO), lithium manganese oxide (LMO), Li₄Ti₅O₁₂ and H₂Ti₁₂O₂₅ is used as a material for the electrode material layer 26.

A current collector 30 illustrated in FIG. 6 according to another embodiment of the present disclosure illustrates an embodiment in which the metal oxide film 15 in which the plurality of second through holes 15a has been formed and the conductive layer 25 in which the plurality of third through holes 25a has been formed are formed on each of the top and bottom of the metal foil 5 in which the plurality of first through holes 5a has been formed. That is, the metal oxide film 15 in which the plurality of second through holes 15a has been formed and the conductive layer 25 in which the plurality of third through holes 25a has been formed are formed on the top of the metal foil 5. The metal oxide film 15 in which the plurality of second through holes 15a has been formed and the conductive layer 25 in which the plurality of third through holes 25a has been formed are formed in on the bottom of the metal foil 5. The electrode material layer 26 illustrated in FIG. 5 is formed on the top or bottom of the conductive layer 25 using the same method as the aforementioned method

As described above, in the current collector 30 according to an embodiment of the present disclosure, the metal foil 10 can act as a support, and the conductive layer 25 can be connected to an external electrode (not illustrated) instead of the metal foil 5. Accordingly, weight can be reduced because the thickness of the metal foil 5 is minimized. Furthermore, oxidization on a surface of the metal foil 5 can be suppressed because the conductive layer 25 is formed on the metal oxide film layer 15.

The current collector for a secondary battery according to an embodiment of the present disclosure has advantages in that it can improve durability by removing a natural oxide film of the metal foil and forming a separate metal oxide film and can prevent an equivalent series resistance characteristic between the electrode material layers from being deteriorated by forming the conductive layer on a surface of the metal oxide film. Furthermore, the current collector has an advantage in that it can increase an adhesive force when an electrode material is coated by forming a plurality of through holes and then forming a conductive connection member within the holes.

The current collector for a secondary battery according to an embodiment of the present disclosure may also be widely applied to various types of adhesive fields in addition to various types of secondary battery or super capacitor fields.

What is claimed is:

1. A current collector comprising a metal foil having a plurality of first through holes, a metal oxide film formed on a top or bottom surface of the metal foil, and a conductive layer formed on a top or bottom surface of the metal oxide film,
wherein the plurality of first through holes is filled with a conductive connection member to form the metal foil,
the metal oxide film is formed to have second through holes at locations corresponding to the plurality of first through holes, respectively, on the top or bottom surface of the metal foil, and
the conductive layer is formed to have a third through hole at a location corresponding to each of the second through holes on a top or bottom surface of the metal oxide film.

2. The current collector of claim 1, wherein one of aluminum, copper, and nickel is used as a material for each of the metal foil and the conductive layer.

3. The current collector of claim 1, wherein:
each of the plurality of first through holes has a diameter of 10 to 100 μm, and
an interval between the first through hole is 10 to 500 μm.

4. The current collector of claim 1, wherein:
the plurality of first through holes is filled with a conductive adhesive material so that the conductive connection member is formed to have a height identical with a depth of each of the plurality of first through holes, and
silver(Ag) epoxy is used as the conductive adhesive material.

5. The current collector of claim 1, wherein:
each of the second through hole formed in the metal oxide film and the third through hole formed in the conductive layer is provided in plural,
each of the plurality of second through holes and each of the plurality of third through holes are formed at a location corresponding to the first through hole and communicate with the first through hole, and
when an electrode material layer is formed in the conductive layer, the electrode material layer is connected to conductive connection members formed in the first through holes filled with the electrode material layer.

6. The current collector of claim 5, wherein:
each of the plurality of second through holes and the plurality of third through holes has a diameter identical with a diameter of the first through hole, and
each of an interval between the second through holes and an interval between the third through holes is identical with an interval between the first through hole.
